(19) United States
(12) Patent Application Publication
(10) Pub. No.: US 2010/0076679 A1
(43) Pub. Date: Mar. 25, 2010

(54) SYSTEM AND METHOD FOR REAL TIME BUS SELECTION ARRANGEMENT

(76) Inventor: Younghyun Lee, Seongnam-si (KR)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/207,048

(22) Filed: Sep. 9, 2008

(51) Int. Cl. G06F 3/048; G06F 17/30

(52) U.S. Cl. 701/208; 715/764

(57) ABSTRACT

The disclosure describes systems and methods for real time bus selection. A bus management system provides a user a best bus route choice by indicating in real time graphically where the at least one of multiple buses are located, the buses routes and scheduled stops, and how long until they arrive at the user's stop. This allows the user to arrange his timing to arrive at a particular stop to meet up with the arriving bus. This may be especially convenient during wintry and rainy days where potential passengers do not want to wait for the buses too long braving the elements. This may also be especially convenient when a user needs to expedite his or her commute. The user can foresee the upcoming buses, and select a bus based on minimal wait time and/or travel time as indicated by the bus management system.

### BACKGROUND

One specific means for public transportation is a bus. In many areas, especially urban areas, bus service is a primary resource an individual can use to travel within city limits. Bus services can fit into several classes. Intercity bus services have become an important travel connection to and from various points in a city.

There are many bus routes intersecting, merging and diverging in an urban environment. Typically there are many different bus choices for one to take to go from one place to another. Some public transit bus systems offer express bus service in addition to local bus lines. Local lines provide frequent stops along a route, sometimes two or more per predetermined distance (i.e., a city block or blocks, a mile or miles or any other measure within a city limit), while express lines make fewer stops and traverse the bus route faster. Typically, the only way an individual can decide a preferable bus and/or bus route, is to check a static bus schedule that is produced by a bus company. The current means of providing bus schedules generally provides a template for scheduled bus stops along a bus route.

### SUMMARY

Among other things, the present disclosure describes a bus management system providing a user best a bus route choice by indicating in real time graphically where the at least one of multiple buses are located, the buses routes and scheduled stops, and how long until they arrive at the user's stop. This allows the user to arrange his timing to arrive at a particular stop to meet up with the arriving bus. This may be especially convenient during wintry and rainy days where potential passengers do not want to wait for the buses too long braving the elements. This may also be especially convenient when a user needs to expedite his or her commute. The user can foresee the upcoming buses, and select a bus based on minimal wait time and/or travel time.

One aspect of the disclosure is a method for bus management comprising receiving location information from a user. The location information comprising an origin and a destination. Based on at least on the location information, bus data is determined for at least one bus, wherein the bus data comprises at least a portion of a bus route and a real time bus location. The real time bus location is an approximate location of the at least one bus along the bus route at a time the determining of the bus data takes place. The bus data is sent to a device of the user to facilitate visible display.

Another aspect of the disclosure is a computer-readable medium tangibly encoded with instructions for performing a method for receiving location information from a user. The location information comprising an origin and a destination. Based on at least on the location information, bus data is determined for at least one bus, wherein the bus data comprises at least a portion of a bus route and a real time bus location. The bus data is sent to a device of the user to facilitate visible display.

Yet another aspect of the disclosure is a system comprising a plurality of processors and a detection engine implemented on one of the plurality of said processors for receiving location information from a user. The location information comprising an origin and a destination. A bus information engine implemented on one of the plurality of said processors for facilitating collecting of bus data for at least one bus. The bus data comprising at least a portion of a bus route and a real time bus location. A correlation engine implemented on one of the plurality of processors for correlating the location information and the bus data to produce an optimal bus selection. A transmission engine implemented on one of the plurality of processors for facilitating transmitting of the optimal bus selection to the user.

Yet another aspect of the disclosure is a method for bus management comprising receiving location information from a user. The location information comprising an origin and a destination. Based on at least on the location information, bus data is determined for at least one bus, wherein the bus data comprises at least a portion of a bus route and a real time bus location. The determining further includes transmitting the bus data to the user for facilitating visible display of the bus data for the at least one bus and receiving a selection of the at least one bus based on the bus data. The bus selection and the bus data are correlated, wherein the bus data is updated. The updated bus data is sent to a device of the user to facilitate visible display.

These and various other features as well as advantages will be apparent from a reading of the following detailed description and a review of the associated drawings. Additional features are set forth in the description that follows and, in part, will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the disclosure as claimed.

### BRIEF DESCRIPTION OF THE DRAWINGS

The following drawing figures, which form a part of this application, are illustrative of embodiments systems and methods described below and are not meant to limit the scope of the disclosure in any manner, which scope shall be based on the claims appended hereto.

FIG. 1 is a schematic illustration of an embodiment of an architecture for facilitating an interaction between a user device and a bus management system.

FIG. 2 is an embodiment of an architecture of the bus management system as a communication platform that facilitates interactions with buses and users.

FIG. 3 is an embodiment of a graphical user interface (GUI) a user manages to communicate with the bus management system.

FIG. 4 is an embodiment of graphical representation of the bus data and user location information compiled by the bus management system.

FIGS. 5A-5B are flowcharts illustrating an embodiment for managing and serving bus data.

FIG. 6 is an embodiment of the system components of the bus management system.

### DETAILED DESCRIPTION

Reference will now be made in detail to embodiments of advertisement management systems and methods, examples of which are illustrated in the accompanying drawings. Certain illustrative embodiments of the present disclosure are described below. It is, however, expressly noted that the present disclosure is not limited to these embodiments, but rather the intention is that additions and modifications to what is expressly described herein also are included within the scope of the disclosure. Moreover, it is to be understood that the features of the various embodiments described herein are not mutually exclusive and can exist in various combinations and permutations, even if such combinations or permutations are not expressly made herein, without departing from the spirit and scope of the disclosure.

For the purposes of this disclosure, a computing device (also referred to herein as a “computer”) includes at least one processor and memory for storing and executing program code, data and software. Computing devices may be provided with operating systems that allow the execution of software applications in order to manipulate data. Personal computers, PDAs, wireless devices, cell phones, internet appliances, media players, home theater systems, and media centers are several non-limiting examples of computing devices. The user interface that is used to display the media content and advertisements is implemented on a computing device and will be understood by one of skill in the art.

For the purposes of this disclosure, a server comprises software and/or hardware running on one or more computing devices which receives information requests from other servers, user computers, or other computing devices, and responds to such requests. A number of program modules and data files may be stored on a computer readable medium of the server. They may include an operating system suitable for controlling the operation of a networked server computer, such as, but not limited to, the WINDOWS VISTA, WINDOWS XP, or WINDOWS 2003 operating systems published by Microsoft Corporation of Redmond, Wash., the Ubuntu operating system distributed by Canonical Ltd. of Douglas, Isle of Mann.

For the purposes of this disclosure, a computer readable medium is a medium that stores computer data in machine readable form. By way of example, and not limitation, a computer readable medium can comprise computer storage media as well as communication media, methods or signals. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology; CD-ROM, DVD, or other optical storage; cassettes, tape, disk, or other magnetic storage devices; or any other medium which can be used to tangibly store the desired information and which can be accessed by the computer. Illustrative embodiments of the disclosure relate to an arrangement for a user to plan an optimal bus route for traveling to a desired destination by taking into account not only which bus arrives at the station first, but also how far the user has to walk from the user location to a particular bus' station (all possible buses in the neighborhood may not stop at the same place).

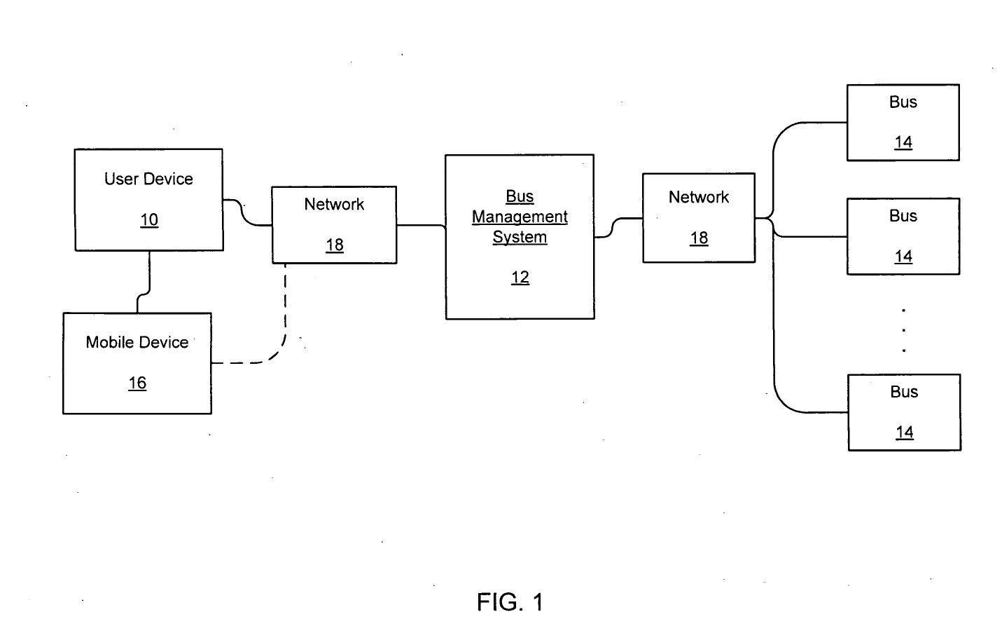

Referring now to FIG. 1, one embodiment of a user interacting with a bus management system is depicted. A user device 10 communicates with the bus management system 12 over a communications network 18. The communication network 18 includes a server or servers that are capable of interacting using the protocol typical to a computer network. Servers may be provided as a group of server systems logically acting as a single server system referred to herein as a server farm, within the network 18. The network 18 can be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 18 may comprise a wireless link, such as an infrared channel or satellite band. The network 18 can also be a local area network (LAN), a metropolitan area network (MAN), a wireless network, a wide area network (WAN) such as the Internet, or any other communication network known in the art. Network 18 topology may be of any such network or network topology as known to those ordinarily skilled in the art capable of supporting the operations described herein.

The user device 10 provided can be any device capable of displaying data capable of operating in accordance with the protocols disclosed herein, such as personal computers, windows-based terminals, network computers, information appliances, X-devices, workstations, mini computers. The mobile device 16 provided can be any type of mobile device, for example, personal digital assistants, cell phones or any other type of communicating device. In some embodiments, the mobile device 16 can also be a laptop computer, as in some instances, some user's utilize a laptop computer as a mobile terminal.

The bus management system 12 provides the user device 10 and/or mobile device 16 with real time bus data corresponding to information the user requires for selecting and/or viewing an optimal bus route and/or bus. Once the user device 10 receives the current bus data for the desired bus, the bus data may be then transmitted to the mobile device 16. The mobile device may implement GPS tracking of the mobile device. This embodiment provides the user device 10 the availability to download bus data to the mobile device 16 in order to receive update/real-time data in the instance that data relating to the user or selected bus changes. According to some embodiments, real-time data may be an approximate location of a bus at a time of determination. In some embodiments, several bus routes may get the user to the desired destination, but the starting point may not be at exactly from the same station place. For example, two bus stops nearby to the user may have differing distances from the current user's location. One bus stop may be a further walk then the other. Therefore, in some embodiments, the bus management system 12 receives information corresponding to the user's current location, through GPS tracking of a user's mobile device 16, and can provide timing of a particular bus to reach a particular bus stop. In some embodiments, the user's identified origin and/or destination may not be at a distinct bus stop for any bus, therefore, the bus management system can determine the closest bus stops in based on bus routes and a user's identified location. This is beneficial because the user can use the timing information of the bus in order to figure out whether it is possible to catch that bus, or to select a different bus and/or bus stop based on the received real-time data at the user's mobile device 16 from the bus management system 12.

The bus management system 12 receives bus information relating to bus location and bus schedule data from each of the buses 14 over network 18. The buses 14 may comprise a range of one bus or a plurality of buses. In some embodiments, the bus management system 12 may poll the buses 14 periodically to record up-to-date data for each bus 14 to be communicated with the user device 10 and/or mobile device 16, as discussed above. In some embodiments, the bus management system 12 may maintain a constant connection with the buses 14 as to maintain real-time bus data for each bus 14.

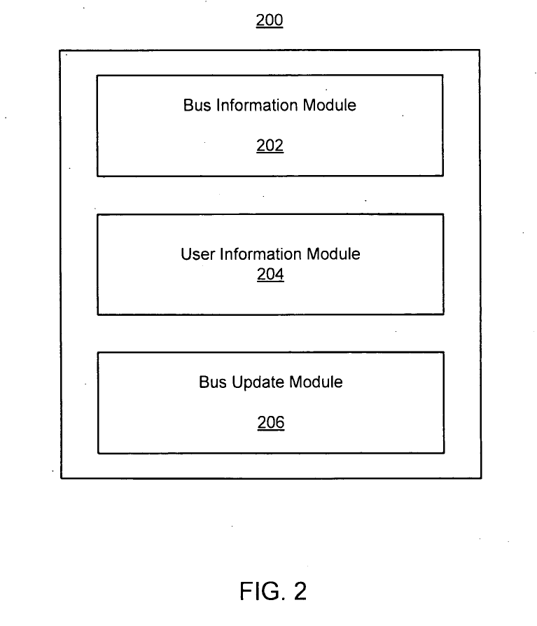

As shown in FIG. 2, an embodiment of a bus management system acting as a communication platform 200 for receiving bus data and user information is depicted. The bus management system 200 provides functionality and support to collect bus data corresponding to each bus in communication with the bus management system 200, collect user information relating to a desired bus route and/or bus, and correlating the bus data and user information for communication to a user with respect to an optimal bus route and/or bus for the user's commute. The bus management system 200 includes at least the following functionality, services, operations, logic or components: 1) a bus information module 202, 2) user management module 204, and 3) a bus update module 206. The bus management system 200 components 202, 204, 206 may include any type and form of application programming interface, programming language, and tools and use any type and form of one or more communication, networking or application layer protocols to interface or communicate with a user (or user) and a bus (or buses).

The user management module 204 collects user information for each user in communication with the bus management system. In some embodiments, the user management module 204 will require the user to log in or register with the system. This is necessary because in some instances, a user may desire bus information for an identical route, or location information (origin and destination). For example, when a user takes the bus to and from work during the week, the user would desire bus information for the same origin and destination at least five days of the week. In some embodiments, once a user has used the system in the past and subsequently logs into the bus management system 200, the user management module 204 will retrieve previously collected bus information and present the bus information to the user. If this bus information is not the desired information, the user will then submit new location information. The user management module 204 will store this information accordingly. In some embodiments, the bus management system 200 will await user input prior to determining bus information for presentation to the user. In some embodiments, the user management module 204 has collected and compiled the user information corresponding to an identity and location information. Once the location information is present for a user, the location information will then be transferred or communicated to the bus information module 202.

The bus information module 202 collects bus data for each of the buses monitored by the bus management system 200. In some embodiments, the bus information module 202 receives information relating to multiple buses, multiple bus companies, multiple bus routes and schedule bus stops of each of the multiple buses. The bus data collected comprises at least a portion of the bus route for each bus and the current location of each bus. In some embodiments, only a portion of the bus route will be collected due to origin and/or destination the user has input, as received by the user management module 204. In some alternative embodiments, the bus information module will collect information for the entire bus route. In some embodiments, the bus data may also comprise the timing of each bus corresponding to its arrival at a predetermined location or bus stop. The predetermined location and/or bus stop (origin and/or destination) is designated by the user as collected by the user management module 204, as discussed above.

With regard to the information compiled by the user management module 204 and the bus information module, the bus update module 202 may poll each of the buses being monitored and/or maintain an open connection with each bus so that up to date and/or real-time data for each bus relating to current location and timing for arrival at each stop is readily available to be presented to a user. This information may be presented to the user at the user's device or mobile device, as discussed above. Each bus may also implement GPS tracking protocol (position tracking), so that the bus update module can monitor current location information in real time for each bus, and provide a timing schedule for each bus to arrive at a designated bus stop.

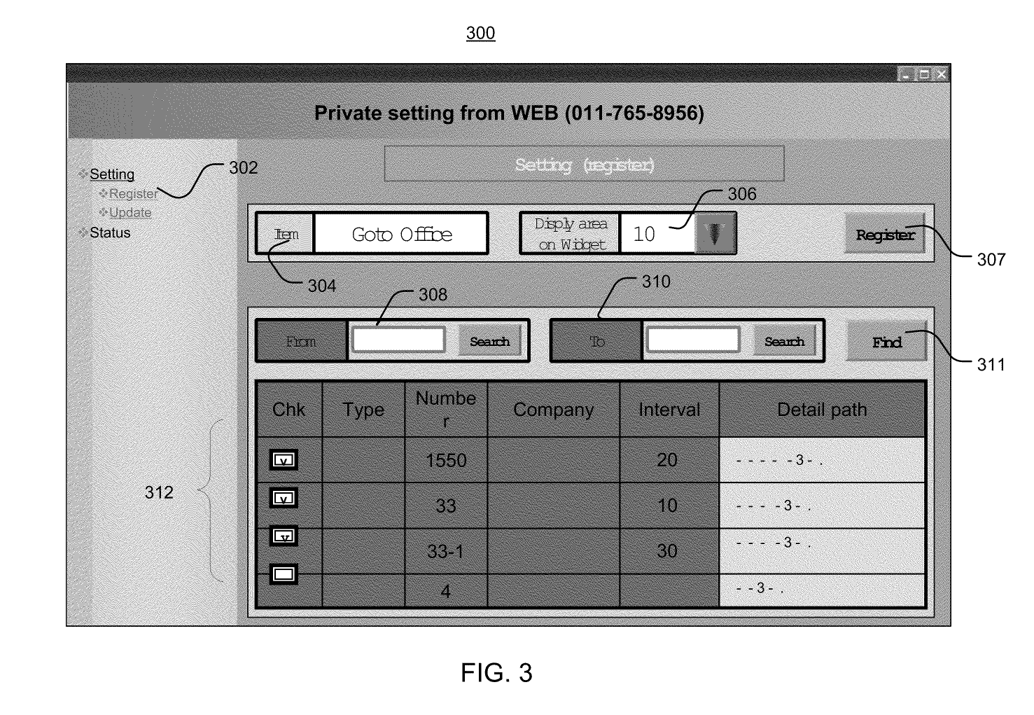

As shown in FIG. 3, an embodiment of a graphical user interface (GUI) 300 a user may utilize to manage and receive data corresponding to bus data communicated from a bus management system. The GUI 300 provides the user the ability to send and receive information to and from the bus management system. Initially, according to some embodiments, the user will provide an input corresponding to registering (logging in) to the bus management system by selecting the register link 302. Once the user has registered, a number of features are presented to the user. Item 304 provides the user the ability to select and/or input a name for the desired bus path. This option allows the user to quickly access past searches if the desired bus path is frequently searched. Upon selecting an option in item 304 that corresponds to a past search, the bus management system will be prompted to produce bus data corresponding to the past search. The bus data from the past search will reveal an origin, destination, and other associated bus information, as will be discussed below. Item 306 allows the user to input the type of device as to where the information will be received. For example, the user may input or select a device corresponding to a user device (PC or terminal) or a mobile device (cellular phone), as discussed in FIG. 1. Items 304 and 306 may be either an input text box, or a drop down menu. The information input into items 304 and 306 will be transmitted to the bus management system upon the selection of the register button 307.

The GUI 300 further provides a user to input location information for a bus and/or bus route search. Item 308 permits the user to input an origin location. The origin location can be either a predetermined bus stop or the user's current location, or a location the user desires to catch a bus from. Item 310 permits the user to input a destination location. The destination location can be either a predetermined bus stop or a location the user desires to exit the bus. The bus management system is able to correlate the origin location and destination location to produce at least one option of an optimal bus stop to catch a bus. The user then submits this information to the bus management system by selecting the find button 311.

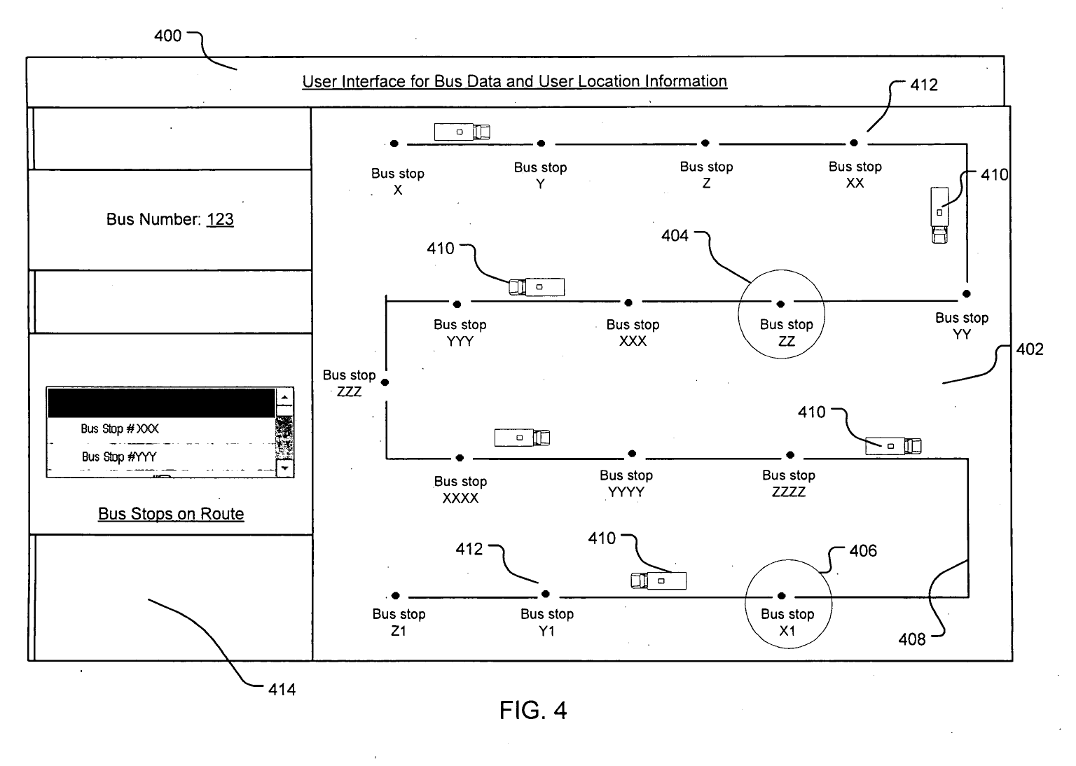

The bus management system receives the information produced from at least items 308 and 310 and produces bus information for at least one bus, as displayed in information field 312. The bus information at least comprises a type of bus (express or local), bus number (on a bus route), bus company, interval of buses deployed (timing schedule of buses on a particular route) and a detailed path of the buses along a route (which may depict the number of bus stops on a particular route, and/or the number of bus stops between an input origin and destination). The information in field 312 may be produced from a previous bus route search initiated upon registering a search upon selection of button 307, as discussed above, or upon selecting the find button 311 after inputting data relating to the origin (item 308) and destination (item 310), as discussed above. The information in field 312 may also be a product of compiling both information, whereby the data is updated real-time data corresponding to data received on a mobile device, as discussed above. Once the information field 312 is populated, the user may select which bus is optimal. After the selection of an optimal bus route, the bus management system transmits the corresponding bus data to the user, as seen in FIG. 4.

As shown in FIG. 4, an embodiment of a graphical representation 400 of the bus data and user location information compiled by the bus management system. The user location information corresponds to the data input into the GUI of FIG. 3. The graphical representation, which appears on a user interface of a mobile device or a user's computer, depicts the compiled results that are output from the bus management system to the user in field 402. The output graphically identifies the location information as input by the user. The location information, comprising an origin (or starting point) 404, and a destination 406 along a bus route 408. The bus route 408 corresponds to the selected bus, as discussed in FIG. 3. The selected bus is identified in the field 414. Field 414 and the information in the field 402 correspond to location information retrieved from a user and bus data retrieved from each bus that are compiled from by the bus management system and transmitted to the user for display on the user device. Field 414 may comprise at least information relating to bus stops 412 for each identified bus 410, or the bus stops 412 on the bus route 408. Further illustrated in the field 402 are bus stops 412 and buses 410 on the displayed bus route 408. Each of the buses 410 are graphically depicted on the bus route 408 according to the time interval displayed in information field 312 of FIG. 3. The embodiment of FIG. 4 is non-limiting, in that, multiple bus routes and corresponding bus information may be displayed together (or simultaneously) on the same graphical representation 400 of FIG. 4. For example, there could be multiple alternative bus routes (of same bus number and/or different bus number) displayed to the user based on the same bus data and user location information.

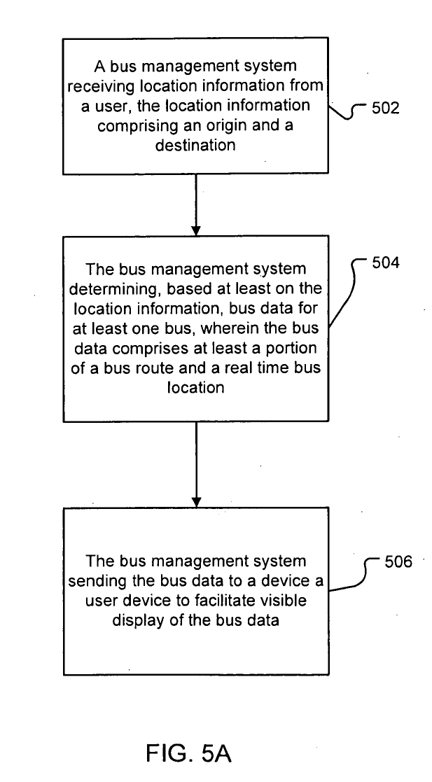

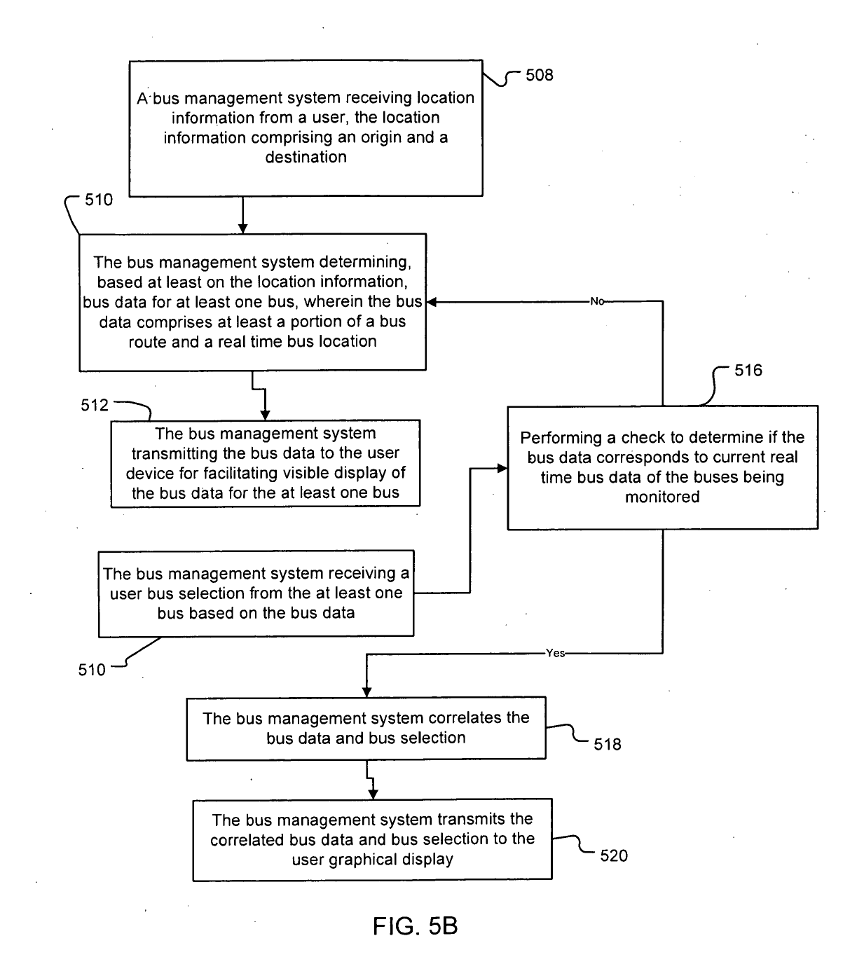

As discussed in FIGS. 5A-5B, embodiments of a bus management system for managing and serving bus information based on user location information and bus data for each bus. FIG. 5A depicts the bus management system receiving data from a user and a bus, and subsequently transmitting the information to the user for use via a user device. The bus management system initially receives location information from a user, step 502. The location information comprises an origin and a desired destination, as discussed above. The bus management system determines bus data for at least one bus, step 504. The bus data comprises at least a portion of a bus route and a real time bus location. According to some embodiments of the disclosure, the bus management system compiles the bus data from information received from at least one of a plurality of bus nodes based on the location information received from the user. Only pertinent bus data corresponding to bus routes and buses that travel the origin and destination as input by the user are included in the compiled bus data. The bus management system subsequently transmits compiled bus data to the user to facilitate visible display on the user device, step 506.

In some embodiments, the bus management system may be correlating real-time bus data and/or user location information, as discussed in FIG. 5B. As discussed in FIG. 5A, the bus management system receives location information comprising an origin and a desired destination information from a user, step 508. The bus management system determines bus data for at least one bus based on the received location information for the user, step 510. The bus data transmits the bus data to the user, step 512. The bus management system then receives a user bus selection based on the bus data for the at least one bus, step 514. The user bus selection may be at least one bus the user identifies as an optimal bus and bus route to take to get from the identified origin to the destination. Upon reception of the user bus selection, the bus management system performs a check to determine if the bus data corresponds to the current real time bus data received from the buses being monitored, step 516. If the bus data has been updated (if the real-time bus data has changed), then the process proceeds back to step 512, where the bus management system will transmit the updated bus data to the user. This step is ideal so that the user may stay up-to-date of current scheduling issues that may arise on a bus' route. For example, if a bus breaks down, encounters traffic, encounters a detour, gets a flat tire, or encounters bad weather, or any other foreseeable or unforeseeable factor that could either slow down or speed up a bus, the user should be kept aware of timing/scheduling changes in order to maintain an optimal and desired bus and/or bus route. If no updates occur, the process proceeds to step 518 where the information is correlated by the bus management system. The correlated information is transmitted to the user for a graphical display, step 520. The graphical display of the correlated bus selection is based on the current bus data and location information. In some embodiments, the user may select to transmit the information from the user device to a mobile device for bus data monitoring, or select the bus management system to communicate directly with a mobile device.

In some embodiments, the bus management system may collect data relating to how crowded a particular bus is at a particular bus stop or bus stops. In some embodiments, buses may comprise means (i.e., a counter) to track how many passengers each bus has at each bus stop along a bus route. That information may be communicated to a dispatcher who then may upload the information to the bus management system. In some alternative embodiments, a user may know how crowded a bus is along a particular bus route according to their own collected historical data relating to user experience. The data indicating how crowded a particular bus is at or after certain bus stops along certain bus routes during varying times of the day may be communicated from the bus, to the bus management system and substantially simultaneously to the user.

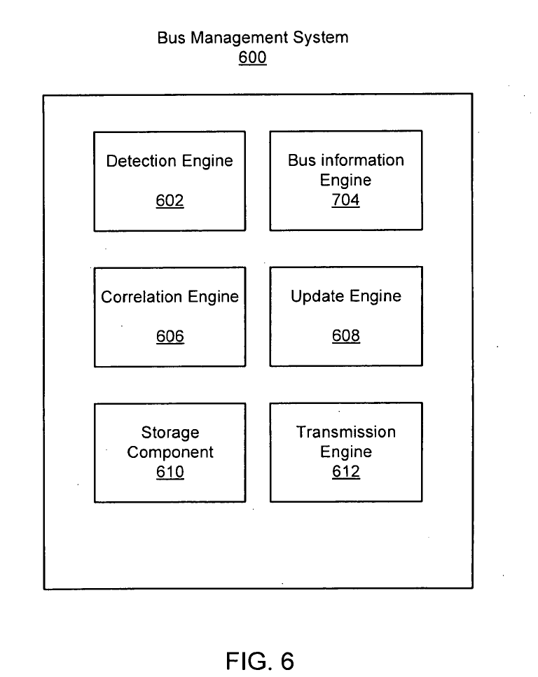

As discussed above in relation to FIGS. 2-5B, the bus management system interacts with users and buses with at least the purpose of serving information to the user based on available bus data and user input information, as shown in FIG. 6. The bus management system 600 includes a detection engine 602, bus information engine 604, correlation engine 606, update engine 608, a storage component 610 and a transmission engine 612. The detection engine 602 within the bus management system 600 receives information from at least one user for use in managing a user's location information, as discussed above. The bus information engine 604 within the bus management system 600 facilitates collecting of bus data for at least one bus, as discussed above. The update engine 608 of the bus management system 600 facilitates monitoring each bus having information collected information from the bus information engine 604, in order for real-time data of the buses relating to current location and timing for arrival at each stop is readily available to be presented to a user, as discussed above. The correlation engine 606 within the bus management system 600 correlates the user information from the detection engine 602, bus information from the bus information engine 604 and, if necessary, the update engine 608. The transmission engine 612 of the bus management system 600 facilitates transmission of the data output from the correlation engine 606 to the user. The bus management system 600 also maintains a storage component 610. The storage component 610 can store the information produced from the detection engine 602, the bus information engine 604, the correlation engine 606, the update engine 608, and the transmission engine 612. The storage component 610 can be a database or any other type of device or component known within the art for storing real-time data. The storage component 610 can be periodically updated depending on the frequency of updated, transmitted and/or received data. In some embodiments, the storage component 610 is updated each time new information is received or transmitted by the bus management system 600. Alternatively, the storage component 610 may be external to the bus management system 600.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. Numerous other changes may be made that will readily suggest themselves to those skilled in the art and which are encompassed in the spirit of the disclosure(s) disclosed.

What is claimed is:

1. A method for bus management comprising:
receiving location information from a user, the location information comprising an origin and a destination;
determining, based at least on the location information, bus data for at least one bus, wherein the bus data comprises at least a portion of a bus route and an approximate location of the at least one bus along the bus route at a time of said determination; and
sending the bus data to a device of the user to facilitate visible display to the user.

2. The method of claim 1, wherein the determining bus data further comprises:
transmitting the bus data to the user device for facilitating visible display to the user of the bus data for the at least one bus;
receiving a selection of the at least one bus based on the bus data; and
correlating the bus selection with the bus data.

3. The method of claim 1, wherein the sending of the bus data further comprises facilitating transmitting of the updated bus information a mobile device of the user.

4. The method of claim 1, further comprising:
receiving registration information from the user, the user information identifying the user; and
downloading the registration information, the registration information being stored in a database
storing the location information for the user in a database.

5. The method of claim 4, wherein the registration information is utilized to recognize the user as a repeat user, wherein the bus data is based on registration information.

6. The method of claim 4, further comprising:
storing the location information for the user in a database.

7. The method of claim 1, further comprising:
sending the bus data to the user device to facilitate a graphical representation based on the bus data and the location information.

8. The method of claim 2, further comprising:
polling the at least one bus for an update of the approximate location; and
transmitting the updated bus location to the user device.

9. The method of claim 1, further comprising:
determining the approximate location based on GPS data received from the at least one bus.

10. The method of claim 1, further comprising:
sending the bus data to a mobile device.

11. The method of claim 1, further comprising:
determining the bus data for a plurality of buses.

12. A computer readable medium tangibly encoded with instructions for performing a method, comprising:
receiving location information from a user, the location information comprising an origin and a destination;
determining, based at least on the location information, bus data for at least one bus, wherein the bus data comprises at least a portion of a bus route and an approximate location of the at least one bus along the bus route at a time of said determination; and
sending the bus data to a device of the user to facilitate visible display to the user.

13. The computer readable medium of claim 12, wherein the determining bus data further comprises:
transmitting the bus data to the user device for facilitating visible display to the user of the bus data for the at least one bus;
receiving a selection of the at least one bus based on the bus data; and
correlating the bus selection with the bus data.

14. The computer readable medium of claim 12, wherein the sending of the bus data further comprises facilitating transmitting of the updated bus information a mobile device of the user.

15. The computer readable medium of claim 12, further comprising:
receiving registration information from the user, the user information identifying the user; and
downloading the registration information, the registration information being stored in a database
storing the location information for the user in a database.

16. The computer readable medium of claim 15, wherein the registration information is utilized to recognize the user as a repeat user, wherein the bus data is based on registration information.

17. The computer readable medium of claim 15, further comprising:
storing the location information for the user in a database.

18. The computer readable medium of claim 12, further comprising:
sending the bus data to the user device to facilitate a graphical representation based on the bus data and the location information.

19. The computer readable medium of claim 13, further comprising:
polling the at least one bus for an update of the approximate location; and
transmitting the updated bus location to the user device.

20. The computer readable medium of claim 12, further comprising:
determining the approximate location based on GPS data received from the at least one bus.

21. The computer readable medium of claim 12, further comprising:
sending the bus data to a mobile device.

22. The computer readable medium of claim 12, further comprising:
determining the bus data for a plurality of buses.

23. A system, comprising:
a plurality of processors;
a detection engine implemented on one of the plurality of said processors for receiving location information from a user, the location information comprising an origin and a destination;
a bus information engine implemented on one of the plurality of said processors for facilitating collecting of bus data for at least one bus, the bus data comprising at least a portion of a bus route and an approximate location of the at least one bus along the bus route at a time said collection;
a correlation engine implemented on one of the plurality of processors for correlating the location information and the bus data to produce an optimal bus selection; and
a transmission engine implemented on one of the plurality of processors for facilitating transmitting of the optimal bus selection to the user.

24. The system of claim 23, further comprising:
a storage component for storing the information produced from the detection engine, the bus information engine, the correlation engine, the update engine, and the transmission engine.

25. The system of claim 23, further comprising
an update engine implemented on one of the plurality of said processors for facilitating monitoring the bus data for the at least one bus, said monitoring providing the correlation engine with an updated approximate location of the at least one bus.
